(19) United States
(12) Patent Application Publication
(10) Pub. No.: US 2026/0134224 A1
(43) Pub. Date: May 14, 2026

(54) SCHEMATIC REPRESENTATION UNDERSTANDING USING MACHINE LEARNING

(71) Applicant: Adobe Inc., San Jose, CA (US)

(72) Inventors: Parth Shailesh Patel, Vadodara (IN); Ankit Bal, Noida (IN)

(73) Assignee: Adobe Inc., San Jose, CA (US)

(21) Appl. No.: 18/942,726

(22) Filed: Nov. 10, 2024

(51) Int. Cl. G06F 40/40; G06F 40/177; G06T 7/10; G06T 7/70; G06V 30/412

(52) U.S. Cl. CPC G06F 40/40; G06F 40/177; G06T 7/10; G06T 7/70; G06V 30/412; G06T 2207/30176

(57) ABSTRACT

Schematic representation understanding using machine learning is described. In one or more examples, one or more layout elements are identified that are included in a schematic representation in digital content. A content stream is extracted from the digital content usable to render the schematic representation. Schematic layout data is then generated by filtering the content stream and identifying data points associated with the schematic representation based on the filtered content stream. A schematic understanding result is output based on the schematic layout data.

### BACKGROUND

Machine-learning models have been developed to leverage deep learning techniques based on training data to implement natural language understanding. The machine-learning models are trainable to enable these models to comprehend, interpret, and produce a variety of responses. Machine-learning models, for instance, are usable to convert text into a series of tokens which is used as a basis to output text as a result. An example of a type of machine-learning model that is trainable to do so is referred to as a large language model (LLM), which has found use in a variety of natural language understanding implementation scenarios.

Conventional techniques that are used to implement natural language understanding of an input using machine-learning are typically tasked with processing text inputs to produce a corresponding text output, e.g., to draft text, answer text questions, and so forth. Consequently, these conventional techniques are computationally challenged and often ill-suited for processing and understanding other non-textual types of inputs, which may introduce additional technical challenges.

### SUMMARY

Schematic representation understanding is described that is implemented using machine learning. In one or more examples, a schematic understating system is configurable to process a schematic representation. Schematic representations are configurable to take a variety of forms, such as a chart, circuit diagram, flow diagram, or other translation invariant image representation. In some instances, the schematic representation includes one or more vectors used to convey information. In order to leverage this information, the schematic understanding system is implemented to generate schematic layout data that is usable to describe “what” is represented by the schematic representation and vectors included in the schematic representation. The schematic layout data is then includable as part of a prompt with a query to generate a schematic understanding result using a machine-learning model.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of an environment in an example implementation that is operable to employ schematic representation understanding techniques using machine learning as described herein.

FIG. 2 depicts a system showing operation of a schematic understating system of FIG. 1 in greater detail.

FIG. 3 depicts a system in an example implementation showing operation of the schematic understating system of FIG. 2 in greater detail as producing a schematic understanding result based on a schematic representation from digital content.

FIG. 4 depicts a system in an example implementation showing operation of a segmentation module of FIG. 3 in greater detail.

FIG. 5 depicts a system in an example implementation showing operation of an element identification module of FIG. 3 in greater detail.

FIG. 6 depicts a system in an example implementation showing operation of a content stream extraction module of FIG. 3 in greater detail as extracting a content stream.

FIG. 7 depicts a system in an example implementation showing operation of a stream separation module as separating operations from digital content that are usable to render a schematic representation.

FIG. 8 depicts a system in an example implementation showing operation of a vector detection module of a stream separation module as generating a vector stream.

FIG. 9 depicts a system in an example implementation showing output of schematic layout data by a layout detection module as tabular data.

FIG. 10 depicts a system in an example implementation showing operation of a segmentation module as extracting a schematic representation as a chart configured as a bar chart.

FIG. 11 depicts a system in an example implementation showing operation of an element identification module of FIG. 3 in greater detail as identifying layout elements from a bar chart of FIG. 10.

FIG. 12 depicts a system in an example implementation showing operation of a content stream extraction module as extracting a content stream from digital content based on the layout elements associated with the bar chart of FIG. 10.

FIG. 13 depicts a system in an example implementation showing operation of a vector detection module to detect a vector stream of vector operations usable to render a vector corresponding to a bar of the bar chart of FIG. 10.

FIG. 14 depicts a system in an example implementation showing output of schematic layout data by a layout detection module as tabular data for a green bar of the bar chart of FIG. 10.

FIG. 15 depicts a system in an example implementation showing operation of the segmentation module as extracting a schematic representation as a chart configured as a scatter plot.

FIG. 16 depicts a system in an example implementation showing operation of an element identification module of FIG. 3 in greater detail as identifying layout elements from a scatter plot of FIG. 15.

FIG. 17 depicts a system in an example implementation showing operation of a content stream extraction module as extracting a content stream from digital content based on the layout elements associated with a scatter plot of FIG. 15.

FIG. 18 depicts a system in an example implementation showing operation of a vector detection module to detect a vector stream of vector operations usable to render a vector corresponding to orange triangles of the scatter plot of FIG. 15.

FIG. 19 depicts a system in an example implementation showing output of schematic layout data by the layout detection module as tabular data for orange triangles of the scatter plot of FIG. 15.

FIG. 20 is a flow diagram depicting an algorithm as a step-by-step procedure in an example implementation of operations performable for accomplishing a result of schematic representation understanding using machine learning.

FIG. 21 is a flow diagram depicting an algorithm as a step-by-step procedure in an example implementation of operations performable for training a machine-learning model.

FIG. 22 illustrates an example system including various components of an example device that can be implemented as any type of computing device as described and/or utilize with reference to the previous figures to implement embodiments of the techniques described herein.

### DETAILED DESCRIPTION

### Overview

Conventional machine-learning techniques used to implement natural language understanding of an input are typically tasked with processing text inputs to produce a corresponding text output, e.g., to draft text, answer text questions, and so forth. Although additional techniques have been developed to process non-text inputs, such as digital images, these techniques often fail in real-world scenarios due to a variety of technical challenges that may be introduced that are involved in interpreting non-textual inputs.

An example of one such technical challenge involves resolution in order to accurately interpret vectors disposed within a digital image as to what data points are represented by the vectors. A chart, for instance, may include a vector to represent information as a trend over time. However, conventional techniques used to consume a chart may lack a sufficient resolution in order to generate an accurate answer to a query. Consequently, these conventional techniques are computationally challenged and often fail and/or produce inaccurate results when tasked with processing and understanding other non-textual types of inputs.

Accordingly, techniques and systems are described that address these and other technical challenges through use of schematic representation understanding using machine learning. Schematic representations are configurable to take a variety of forms, such as a chart, circuit diagram, flow diagram, or other translation invariant image representation. In some instances, the schematic representation includes one or more vectors used to convey information, e.g., a line in a chart, circuit in a circuit diagram, and so on. In order to leverage this information, a schematic understanding system is implemented using a computing device in one or more examples to leverage understanding of vector representations included as part of a schematic representation.

The schematic understanding system, for instance, is configurable to detect datapoints based on vectors in the schematic representation to then form a table which is consumable by a machine-learning model (e.g., an LLM) to produce a schematic understanding result. A schematic representation of a chart of amounts of rainfall for a month, for instance, is processed by the schematic understanding system and used to generate a table which then supports queries using the LLM. A query, for instance, may then be received for “which day of the week is the wettest” and a schematic understanding result is then formed by an LLM based on the query and the table which are fed as a prompt to the LLM.

To begin in one or more examples, digital content is received by a schematic understanding system, e.g., a digital document, digital slide, digital movie, and so forth. The schematic understanding system then segments a schematic representation from the digital content, e.g., using machine-learning to implement segmentation and/or classification.

The schematic representation, as segmented from the digital content, is then processed by the schematic understanding system to identify layout elements associated with the schematic representation. The layout elements are usable to convey information that is represented by the schematic representation. As such, the layout elements are configurable in a variety of ways. Examples of layout element configurations include a title, axis title, axes, gridlines, data series, legend, “ticks,” plot area, chart area, annotations, error bars, trendlines, markers, shading, highlighting, and so on.

The layout elements, for instance, are identified using a machine-learning model (e.g., an LLM) to leverage chart metadata to identify whether the schematic representation is a chart, what type of chart, chart information such as axis labels, and so on. A content stream is then extracted by the schematic understanding system. The content stream, for instance, leverages a location of the schematic representation within the digital content to extract a content stream associated with the schematic representation from the digital content. The content stream, for instance, may include identifying (e.g., via filtering) vector operations from the content stream used to render vectors and text operations from the content stream used to render text.

The schematic understanding system then utilizes the identified layout elements to generate schematic layout data that describes datapoints, e.g., corresponding to the vectors as based on associated text using the filtered content stream. The schematic layout data, for instance, is configurable as tabular data. For example, the tabular data is configurable using corresponding column headers based on an X-axis label, Y-axis label, chart legend, or so forth. For a line graph, for instance, the schematic layout data identifies points of intersections of lines and associated each point (e.g., based on a corresponding color) to an appropriate legend name. For a scatter plot, the datapoints are recognized and associated with an appropriate legend name, e.g., based on a search to obtain values of the datapoints.

In an example of a portable document format or other document format having layers, the techniques described herein support disambiguation of various aspects of the digital content, e.g., a digital image of a chart, schematic diagram, and so on. The schematic understanding system, for instance, may receive digital content depicting a house layout having multiple layers from furnishing to electrical wiring and plumbing. Layers including optical content groups (OCGs) are therefore usable to separately address the different aspects of the digital content. A vision-based LLM, for instance, of the schematic understanding system is configurable to analyze each of the layers independently to extract relevant metadata from each layer. Once data representations are generated based on the metadata, the schematic understanding system is then configurable to identifying connections and overlaps between layers that provide additional insight and an improved holistic understanding of the digital image, e.g., the schematic, chart, and so forth. In this way, the schematic understanding system is extendable to provide enhanced figure understanding in a scenario involving complex digital content having layers, which is not possible in conventional techniques.

The schematic layout data is then usable to generate a schematic understanding result based on a query, e.g., using a machine-learning model such as an LLM. In this way, accuracy of the LLM in producing the result is improved when compared with conventional techniques through use of operation filtering from a content stream and the tabular data of the schematic layout data. As a result, the schematic understanding system is configurable to increase resolution and therefore corresponding accuracy in understanding “what” is conveyed by a schematic representation, which is not possible in conventional techniques. Further discussion of these and other examples is included in the following sections and shown in corresponding figures.

### Term Examples

A “machine-learning model” refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

A “large language model” (LLM) is a type of machine-learning model that is designed to understand, generate, and interact with human language inputs at a large scale. These machine-learning models are trained on vast amounts of text data using deep learning techniques (e.g., neural networks) to learn patterns, nuances, and the structure of language. The use of the term “large” refers to both the size of the training data and also to the complexity and scale of the neural networks, which may include billions or even trillions of parameters.

Large language models are configurable to perform a wide range of language-related tasks without being explicitly programmed for each one. Examples of these tasks include text generation, translation, summarization, question answering, sentiment analysis, and natural language processing. To train a large language model, the underlying machine-learning model is provided with training data that includes examples of text to train and retrain the model to predict a next word in a sequence. Over time, the model, once trained, is configured to generate text that is coherent and contextually relevant, is configurable to mimic a style and content of the training data, and so forth. In this way, large language models provide a foundational tool in artificial intelligence for understanding and generating human language, powering a wide range of applications from conversational agents to content creation tools.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Schematic Representation Understanding Environment

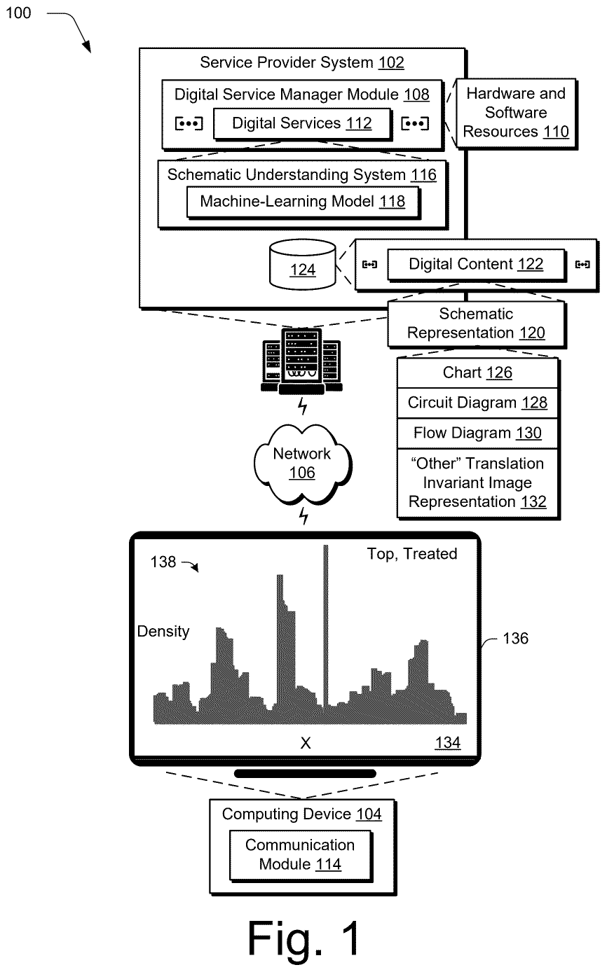

FIG. 1 is an illustration of an environment 100 in an example implementation that is operable to employ schematic representation understanding techniques using machine learning as described herein. The illustrated environment 100 includes a service provider system 102 and a computing device 104 that are communicatively coupled, one to another, via a network 106. Computing devices are configurable in a variety of ways.

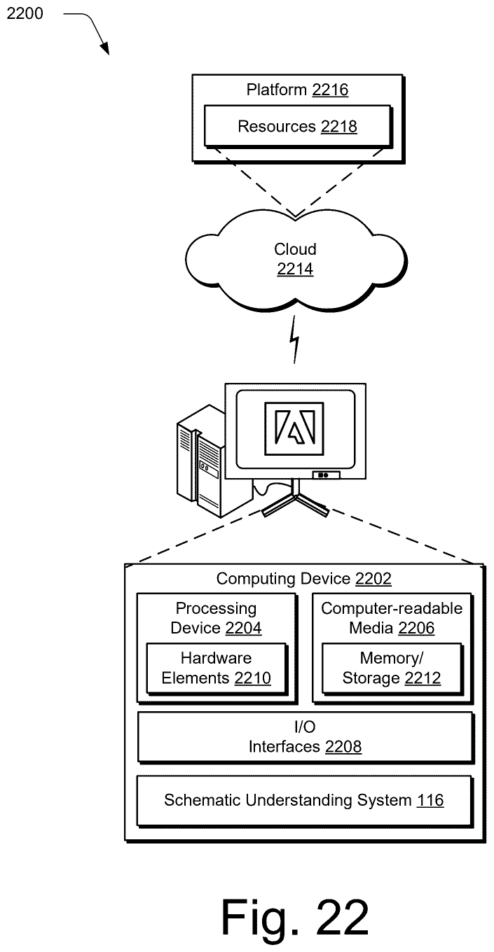

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown and described in instances in the following discussion, a computing device is also representative of a plurality of different devices, such as multiple servers utilized by a business to perform operations “over the cloud” for the service provider system 102 and as further described in relation to FIG. 22.

The service provider system 102 includes a digital service manager module 108 that is implemented using hardware and software resources 110 (e.g., a processing device and computer-readable storage medium) in support of one or more digital services 112. Digital services 112 are made available, remotely, via the network 106 to computing devices, e.g., computing device 104.

Digital services 112 are scalable through implementation by the hardware and software resources 110 and support a variety of functionalities, including accessibility, verification, real-time processing, analytics, load balancing, and so forth. Examples of digital services include a social media service, a streaming service, a digital content repository service, a content collaboration service, and so on. Accordingly, in this example, a communication module 114 (e.g., browser, network-enabled application, and so on) is utilized by the computing device 104 to access the one or more digital services 112 via the network 106. A result of processing using the digital services 112 is then returned to the computing device 104 via the network 106.

In the illustrated example, the digital services 112 are utilized to implement a schematic understating system 116 using one or more machine-learning models 118. The schematic understating system 116 is configurable to process a schematic representation 120, e.g., as included in digital content 122 which is illustrated as stored in a storage device 124. The schematic representation 120 is configurable in a variety of ways, examples of which include a chart 126, a circuit diagram 128, a flow diagram 130, or “other” translation invariant image representation 132.

“Translation invariant” refers to a characteristic is which the schematic representation 120 is convertible into a machine-readable form without loss of data, although visual characteristics that do not relate to the data such as visual non-informational stylizations may be lost. The schematic understating system 116, for instance, is configurable to process the schematic representation 120 into a tabulated form in which semantic meaning across different translation is maintained (e.g., whether table or chart) without data loss. Thus, a schematic representation 120 covers various types of visual representations usable to convey information, processes, or systems in a simplified and standardized manner in a readily consumable manner by a human with increased richness over that offered through sole use of text. Examples of schematic representation 120 includes a chart 126 a circuit diagram 128, a flow diagram 130, and “other” translation invariant image representation 132.

As machine-learning models, and particularly LLMs, continue to develop from initial support of text, alone, to support use of multimodal inputs. However, conventional techniques to do so are not translation invariant and therefore result in loss of data through challenges in data resolution. For example, a chart having hundreds if not thousands of data points that are used to represent information in the chart is problematic in understanding the information using conventional techniques.

To address these and other technical challenges, the schematic understating system 116 is configurable to process a schematic representation 120 and generate schematic layout data that is usable to describe “what” is represented by the schematic representation 120, e.g., using tabular data. As shown in the user interface 134 depicted as rendered and displayed on a display device 136, an example 138 of a schematic representation 120 is shown that is configured as a chart 126. The chart includes vector data used to convey data points for information using respective axis, e.g., “density” and “X.” The example 138 also includes a title that is usable to convey information about an underlying purpose of the chart 126. Through use of the schematic understating system 116, this information is extracted and converted into a form that is consumable by the one or more machine-learning models 118 to generate a schematic understanding result with increased accuracy over conventional techniques.

Portable data format (PDF) digital content, for instance, is popular and often includes schematic representations that employ images and vectors to convey information. Although data extraction from images introduces resolution constraints, vector representations included in charts and other types of schematic representations employ vector elements such as lines, rectangles, circles, curves, and so on which may be leveraged to produce an accurate chart.

Based on this insight, the schematic understating system 116 is configured to extract schematic layout data as high quality data from a schematic representation 120, an example of which includes vector data included in a chart. To do so, the one or more machine-learning models 118 is configurable using a combination of multimodal LLMs, specialized machine-learning models, and machine-learning understanding techniques to generate schematic layout data that is usable to describe the information included in the schematic representation 120.

The schematic layout data is then usable in support of schematic representation understanding techniques, such as to answer a query through processing of the schematic layout data using a machine-learning model, e.g., an LLM. As a result, the schematic understating system 116 overcomes technical challenges of conventional techniques in support of schematic representation understanding through use of the one or more machine-learning models 118. Further discussion of these and other examples is included in the following sections and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Schematic Representation Understanding Example

The following discussion describes schematic representation understanding techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

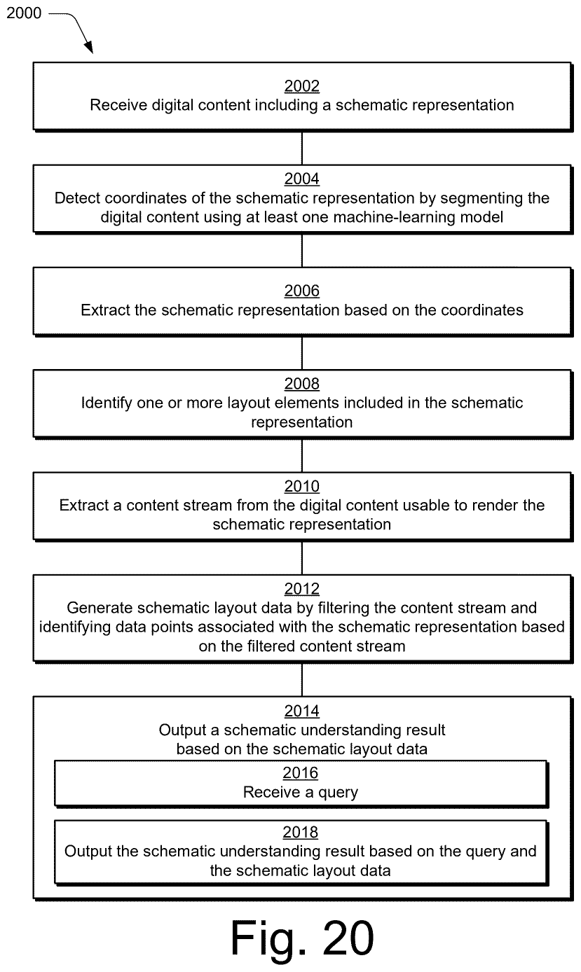

FIG. 20 is a flow diagram depicting an algorithm 2000 as a step-by-step procedure in an example implementation of operations performable for accomplishing a result of schematic representation understanding using machine learning. Discussion of the algorithm 2000 is made in parallel with operation of the schematic understating system 116 in the following description.

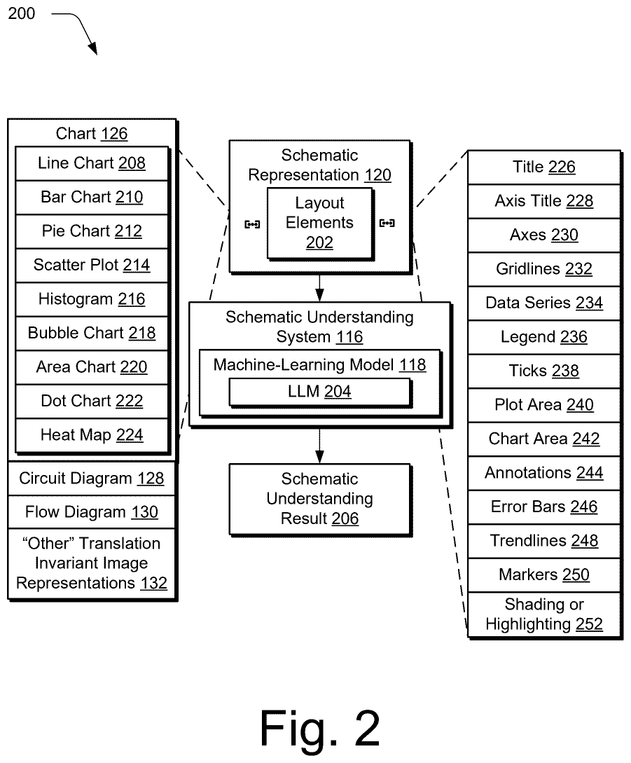

FIG. 2 depicts a system 200 showing operation of the schematic understating system 116 of FIG. 1 in greater detail. The schematic understating system 116 in the illustrated example receives as an input a schematic representation 120. The schematic representation 120 includes layout elements 202 that are processed by a one or more machine-learning model 118 (e.g., using an LLM 204) and used as a basis to produce a schematic understanding result 206. The schematic understanding result 206, for instance, is configurable as an answer to a query, with the answer being based on the layout elements 202 of the schematic representation 120 through processing by the LLM 204.

Examples of schematic representations 120 are illustrated as a chart 126, a circuit diagram 128, a flow diagram 130, and “other” translation invariant image representation 132. A chart 126 provides a readily technique to visualize information in an easily consumable manner by a human being but may be challenging to understand using machine learning.

The chart 126 is configurable in a variety of ways. In a first example, the chart 126 is configured as a line chart 208 having vectors used to represent data points, e.g., over time to indicate trends. In a second example, the chart 126 is configured as a bar chart 210, which is configurable to represent data points as quantities across different categories. In a third example, the chart 126 is configured as a pie chart 212, which is usable to express data points as proportions of a whole and a respective category's contribution to the whole. In a fourth example, the chart 126 is configured as a scatter plot 214 that is usable to define data points as values of two variables for a set of data, e.g., to represent correlations or patterns.

In a fifth example, the chart 126 is configurable as a histogram 216, which is similar to a bar chart and typically used to represent data points for a frequency distribution of numerical data. In a sixth example, the chart 126 is configured as a bubble chart 218, which is used to represent data points similar to a scatter plot with an added criterion involving a relative size of the bubbles. In a seventh example, the chart 126 is configured as an area chart 220 that is configurable similar to a line graph, with data points including an area below a vector that is “filled in” to represent cumulative data over time. In an eighth example, the chart 126 is configured as a dot chart 222 that is configurable to utilize dots to represent data points to illustrate a distribution. In a seventh example, the chart 126 is configured as a heat map 224 that utilizes colors to represent data points in a matrix, e.g., to illustrate data density or intensity. Other examples of a chart 126 are also contemplated, e.g., a Sankey diagram.

The layout elements 202 are also configurable in a variety of ways to provide and support information being conveyed by the schematic representation 120. Examples of layout elements 202 include a title 226, e.g., a main heading that describes an overall information or purpose of the schematic representation 120. In another example, the layout elements 202 include an axis title 228 that is a label that describes criteria of data points, e.g., along an X-axis or a Y-axis. Axes 230 are vectors (e.g., lines) that define a frame of the schematic representation 120, which may include the X-axis or Y-axis as described above. Gridlines 232 refer to lines that are typically disposed horizontally and/or vertically across the schematic representation 120 to aid in alignment and accuracy in reading values of respective data points. A data series 234 refers to actual data points (e.g., using bars, lines, pie slices, points in a scatter plot, and so on) that represent the data being visualized. A legend 236 refers a key used by the schematic representation 120 to explain what different colors, patterns, symbols, and so on in the schematic representation 120 “mean.”

Ticks 238 and tick labels may be expressed as small marks along the axes, which accompanying labels, to indicate specific values or categories. A plot area 240 refers to a region, in which, the data points are plotted and bounded by the axes. A chart area 242 refers to an entire area of the digital content 122 occupied by the schematic representation 120. Annotations 244 refer to additional notes or highlights added to the schematic representation 120 to emphasize particular points or trends. Error bars 246 are configurable as indicators of variability or uncertainty in the data, which are often used in scientific charts to show a margin of error. Trendlines 248 refer to lines that are typically added to a schematic representation 120 to indicate trends or patterns in the data, e.g., a line of best fit in a scatter plot. Markers 250 are configurable as symbols usable to denote individual data points, e.g., in a line or scatter plot. Shading or highlighting 252 is typically utilized to emphasize particular areas or ranges within the schematic representation 120, such as background shading to highlight a period of interest in a time series. Other examples are also contemplated, such as data labels that are used to provide numerical or textual labels to receive data points to increase precision and clarity.

These layout elements 202 together help convey an underlying meaning of information represented by the schematic representation 120, enabling human being to understand and interpret the information presented in the schematic representation 120. The schematic understating system 116, therefore, is configurable to process these layout elements 202 in an manner that is understandable by the LLM 204 of the one or more machine-learning models 118 to produce the schematic understanding result 206, further discussion of which is described as follows and is shown in corresponding figures.

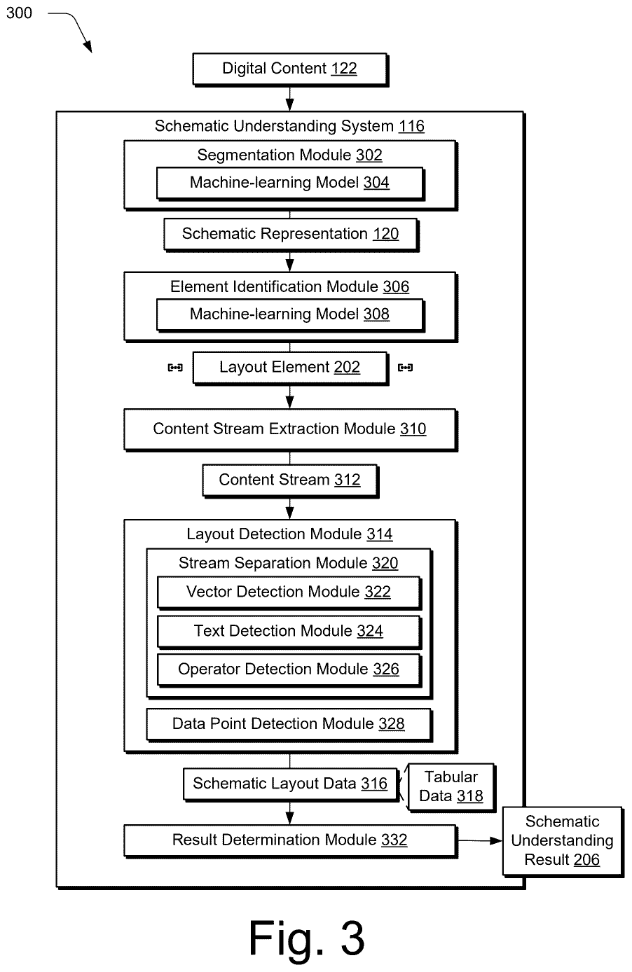

FIG. 3 depicts a system 300 in an example implementation showing operation of the schematic understating system 116 of FIG. 2 in greater detail as producing a schematic understanding result 206 based on a schematic representation 120 from digital content 122. To begin in this example, digital content 122 is received by the schematic understating system 116 that includes a schematic representation 120 (block 2002). The digital content 122 as previously described is configurable in a variety of ways, such as a digital document, digital image, slide, digital book, and so forth.

A segmentation module 302 is employed to segment a schematic representation 120 from the digital content 122 using a machine-learning model 304. The segmentation module 302, for instance, is configurable to detect coordinates of a rendering of the digital content 122 by segmenting the digital content 122 using the machine-learning model 304 (block 2004), e.g., to identify respective bounding boxes of page constructs such as a paragraph, heading, list item, figure, table, and so on. The schematic representation 120 is then extracted by the segmentation module 302 based on the coordinates (block 2006). A variety of other examples are also contemplated.

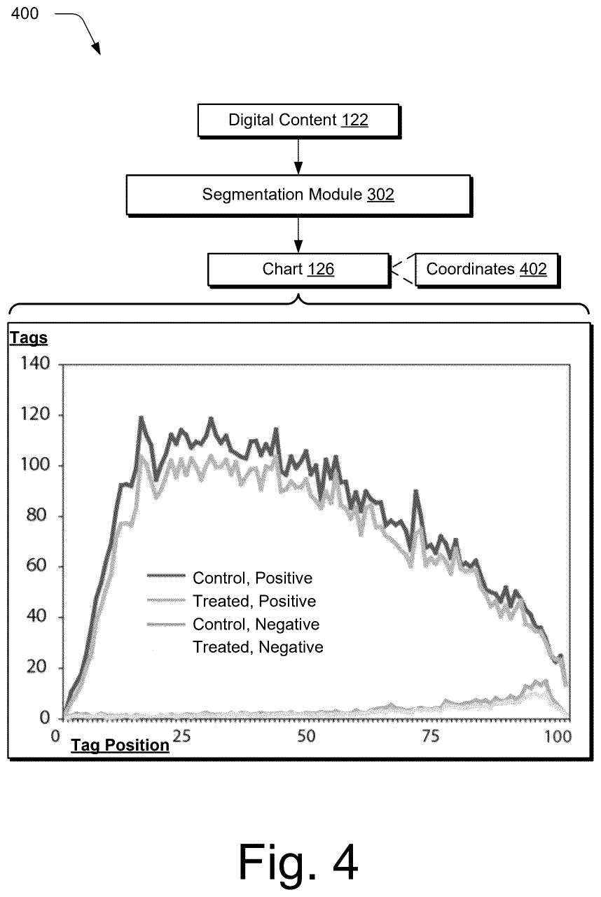

FIG. 4 depicts a system 400 in an example implementation showing operation of the segmentation module 302 of FIG. 3 in greater detail. The segmentation module 302 is configured to analyze and segment different elements on a page of the digital content 122, such as text, images, and graphics. To do so, the segmentation module 302 takes the digital content 122 as an input, e.g., as a PDF, or any other format containing mixed content. The segmentation module 302 then employs the machine-learning model 304 to implement the segmentation technique, e.g., through configuration as a convolutional neural network (CNN) and other deep learning architecture. The chart 126 is then extracted in this example based on coordinates 402 defined for the chart 126, e.g., based on a respective bounding box.

The input, for instance, may be preprocessed by the segmentation module 302 to enhance quality and readability. Preprocessing may include use of techniques such as noise reduction, binarization (converting to black and white), and resizing. The segmentation module 302 is configured to identify and separate text blocks from other layout elements. This involves detecting lines of text, paragraphs, and individual characters. Non-text elements like images, charts, and graphics are also detected and separated from the text by the segmentation module 302.

The segmentation module 302, through the machine-learning model 304, then analyzes the layout to understand a structure of the page, such as columns, headers, footers, and other sections. For each detected element, the model extracts relevant features. For text, examples of relevant features include font size, style, and alignment. Images and graphics examples of relevant features include identification of shapes, colors, and patterns.

The extracted features are then utilized by the segmentation module 302 to classify each element into a respective one of a plurality of predefined categories, e.g., text, image, table, etc. so as to promote understanding of a role of each element in the digital content 122. The segmented elements are then output in a structured format (e.g., a JavaScript Object Notation object) which may also be further processed, e.g., for optical character recognition. Post-processing techniques may also be employed to correct misclassified elements, merging or splitting segments, and so forth.

Returning again to FIG. 3, an element identification module 306 is then employed by the schematic understating system 116 to identify one or more layout elements 202 included in the schematic representation 120 (block 2008). The element identification module 306 is configurable to employ a machine-learning model 308 (e.g., configured as a multimodal LLM) to identify the layout elements as described in relation to FIG. 2.

The element identification module 306 is configurable to identify from the schematic representation 120 and associated metadata from the digital content 122 aspects such as whether the schematic representation 120 is a chart 126, if a chart, what type of chart, and where applicable other layout elements such as chart information including axis title 228, axes 230, ticks 238 (e.g., which define a unit of measure used for a respective axis), and so forth.

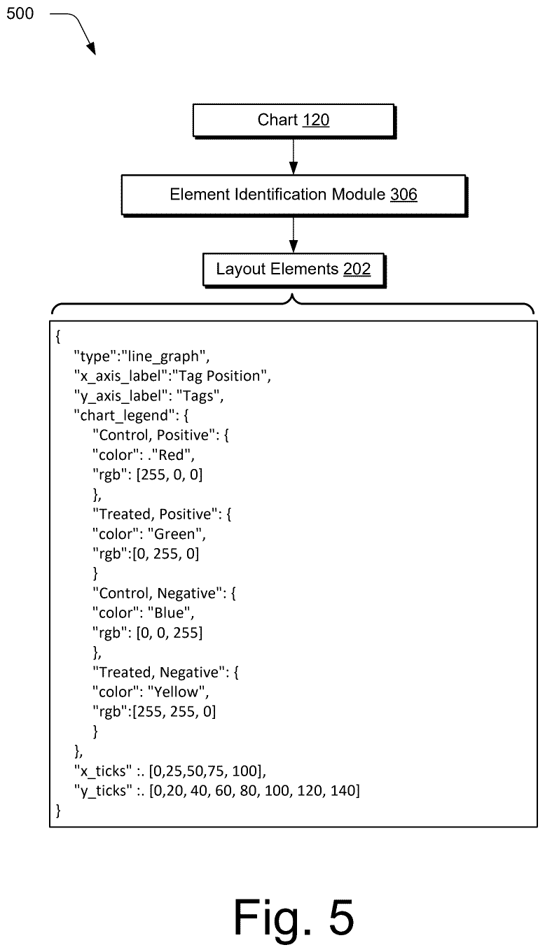

FIG. 5 depicts a system 500 in an example implementation showing operation of the element identification module 306 of FIG. 3 in greater detail. The element identification module 306 is configured to identify the layout elements 202 based on corresponding characteristics. Examples of these layout elements 202 include color in this example. Therefore, the layout elements 202 are identifies as “type,” “x_axis_label,” “y_axis_label,” “chart_legend” with “Control, Positive,” “Positive,” “Negative,” “Treated Negative,” and corresponding colors. Other examples include “x_ticks” and “y_ticks” for the demarcations across respective axes.

Returning again to FIG. 2, a content stream extraction module 310 is then employed to extract a content stream 312 from the digital content 122 using metadata from the digital content 122 that is usable to render the schematic representation (block 2010) and may also include metadata associated with the schematic representation 120. The content stream extraction module 310, for instance, is usable to extract the content stream 312 by retrieving underlying data and graphical elements that make up the layout elements 202.

To do so, the content stream extraction module 310 filters operations of the digital content 122 into a vector stream usable to render one or more vectors of the schematic representation and a text stream usable to render text associated with the schematic representation. The one or more vectors, for instance, are used to plot the data points in the schematic representation 120 and identification of the data points is based on the one or more vectors. This may involve converting vector paths into a consumable format by a machine-learning model, such as a JavaScript Object Notation object, comma separated values, and so forth.

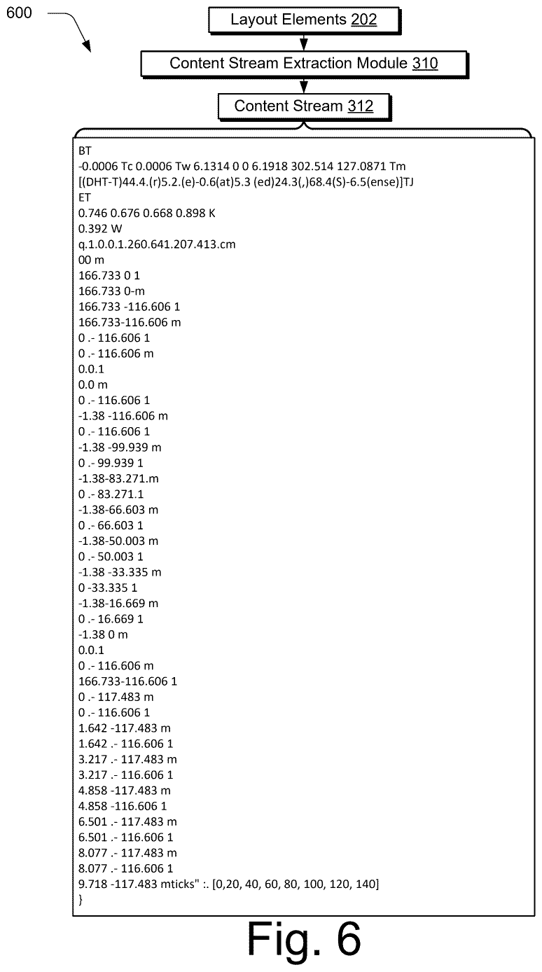

FIG. 6 depicts a system 600 in an example implementation showing operation of the content stream extraction module 310 of FIG. 3 in greater detail as extracting a content stream 312. The content stream 312 in this example includes operations usable to render the chart 126 of FIG. 4, e.g., vector operations usable to render respective vectors as well as a text stream usable to render text.

Returning again to FIG. 3, a layout detection module 314 receives, as an input, the content stream 312. The layout detection module 314 is then employed to generate schematic layout data 316 by filtering the content stream 312 and identifying data points associated with the schematic representation based on the filtered content stream (block 2012). The layout detection module 314, for instance, is configurable to filter the content stream 312 of the chart 126 in the illustrated example using metadata associated with the chart 126 to identify corresponding tabular data 318 through use of a stream separation module 320. The schematic layout data 316, in one or more examples, is configured to filter vector operations and text operations depending on a type of schematic representation 120 being processed through use of a stream separation module 320.

A vector detection module 322, for example, is configured to detect vector operations usable to render vectors. Examples of vector operations include “cm” (i.e., coordinate transformation operator), “m” (i.e., move to a specified point), “l” (i.e., a line operator usable to draw a line between specified points), “re” (i.e., draw rectangle), “f” (fill operator), “K” (i.e., specifies a color in CMYK space), and so forth.

A text detection module 324 is usable to detect text operations. Examples of text operations include “BT” (i.e., begin text), “ET” (i.e., end text), “Tf” (i.e., text font), “K” (i.e., specifies a color in CMYK space), and so forth. An operator detection module 326 is representative of functionality of the stream separation module 320 to identify other types of operations, examples of which include “BMC” (i.e., begin marked content), “EMC” (i.e., end marked content), and so on.

A data point detection module 328 is also employed by the stream separation module 320 to utilize the layout information and metadata associated with the schematic representation 120 of the digital content 122 to identify data points from the vector stream of operations usable to render vectors as part of the schematic representation 120. An output of which is the schematic layout data 316 as tabular data 318 with appropriate column headers which may be based on an x-axis label, y-axis label, legend, and so forth.

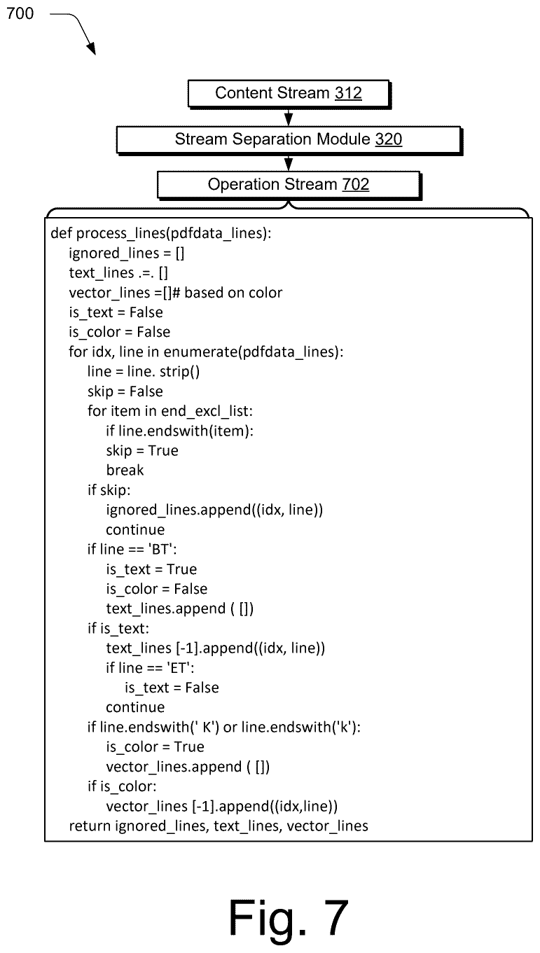

FIG. 7 depicts a system 700 in an example implementation showing operation of a stream separation module 320 as separating operations from the digital content 122 that are usable to render the schematic representation 120. In the illustrated example, the vector stream 702 includes operations that are segregated into vector streams, text streams, and other streams.

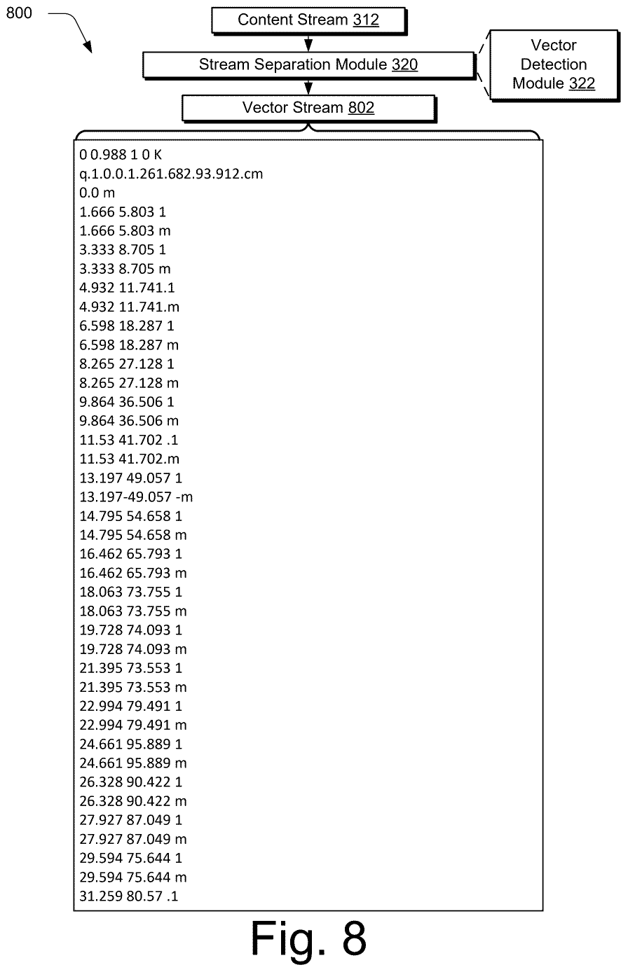

FIG. 8 depicts a system 800 in an example implementation showing operation of a vector detection module 322 of the stream separation module 320 as generating a vector stream 802. In this example, the vector stream 702 includes vector operations used to render vector lines of the schematic representation 120 that are filtered from the separated operations of FIG. 7. The stream separation module 320, for instance, performs a color similarity match between colors found in the digital content 122 and colors output by a multimodal LLM in metadata to find streams for each color/line. As illustrated, color operation is “0,” “0.988,” “1”, “0,” “K” which represents red in a CMYK color space. Successive “m” operators followed by “l” operators are used to draw the constituent lines of the red line, of which, operands to these operators are the X and Y coordinates of data points in the red line.

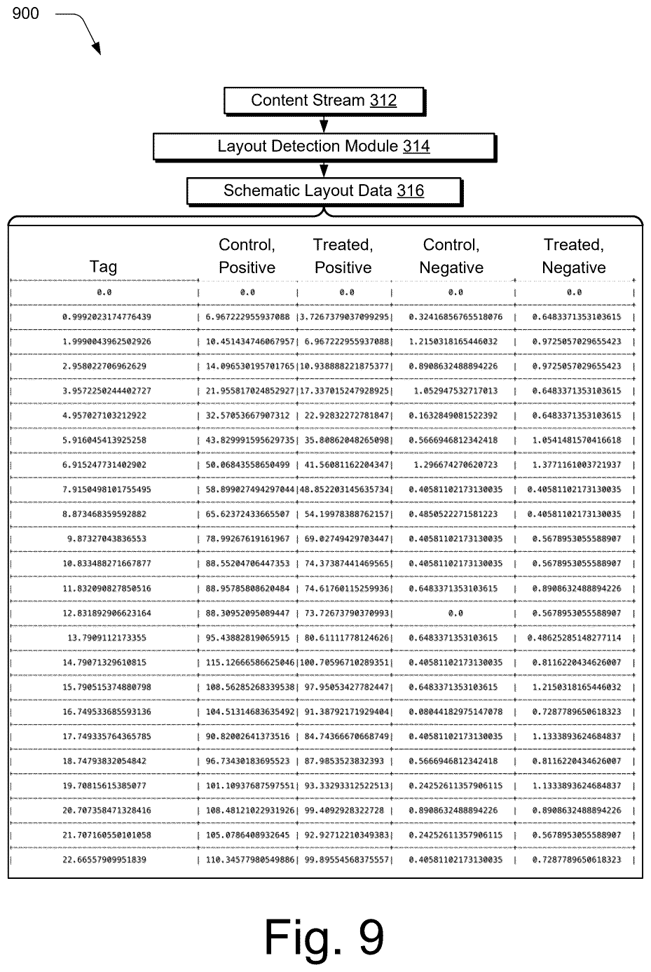

FIG. 9 depicts a system 900 in an example implementation showing output of schematic layout data 316 by the layout detection module 314 as tabular data 318. The schematic layout data 316 details values for data points extracted from the schematic representation 120 into a form that is readily consumable by the one or more machine-learning models 118.

Returning again to FIG. 3, a form of the output of the schematic layout data 316 is dependent on a type of schematic representation 120 being processed. For a line graph, for instance, the schematic layout data 316 identifies points of intersections of lines and associates each data point (e.g., using its color0 to an appropriate legend name. For a scatter plot, the schematic layout data 316 recognizes data points rendered by the streams, e.g., since each data point is rendered using a same sequence of operations, a regex search is usable to obtain the data points. Each data point is then associated with an appropriate legend name, e.g., based on color, shape, style, and so forth. For a bar chart, the schematic layout data 316 recognizes the data points by identifying bars/rectangles in the vector streams and associated each of these elements to a respective legend name, e.g., by color.

In a scenario involving a relatively dense chart 126, the layout detection module 314 is configurable to remove overlapping elements and repeats the process from the beginning to further clarity. In another example, use of optional content groups (OCGs) are toggled to show/hide data as part of content extraction. The schematic layout data 316 may also be normalized to dimensions/units referenced in the schematic representation 120, e.g., using x-tick values, y-tick values, chart dimensions, and so forth.

In this way, the schematic layout data 316 increases richness in describing the schematic representation 120 and thus a corresponding richness in understanding the schematic representation 120. A result determination module 332 may then be employed to output a schematic understanding result based on the schematic layout data 316 (block 2014), e.g., using a machine-learning model such as an LLM. The result determination module 332, for instance, receives a query (block 2016). The vector detection module 322 then forms a prompt that includes the query and the schematic layout data 316 for processing by the one or more machine-learning models 118, which is then output (block 2018). A variety of other examples are also contemplated.

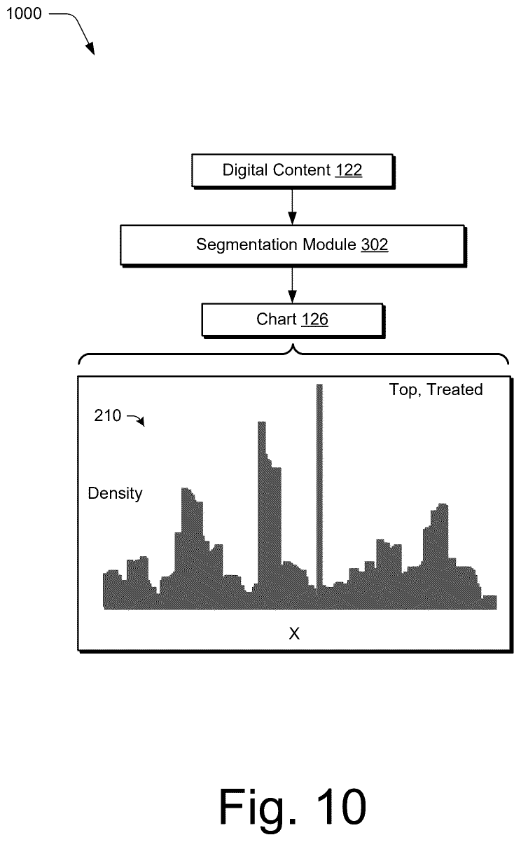

FIG. 10 depicts a system 1000 in an example implementation showing operation of the segmentation module 302 as extracting the schematic representation 120 as a chart 126 configured as a bar chart 210.

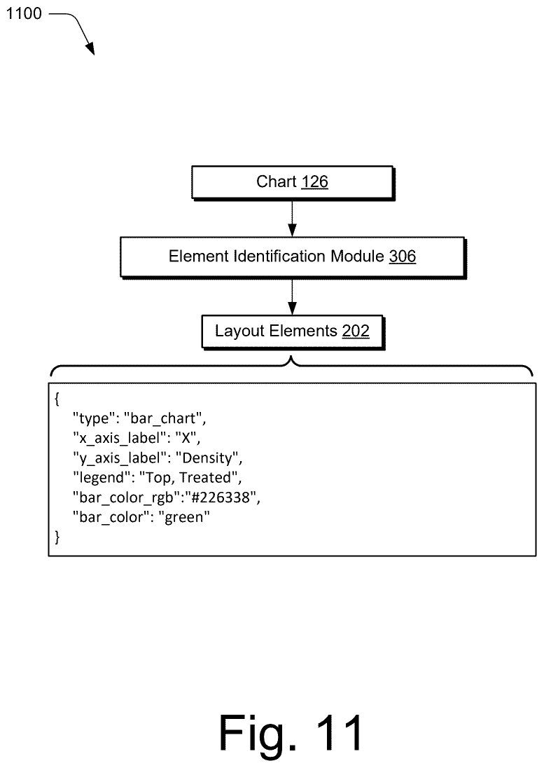

FIG. 11 depicts a system 1100 in an example implementation showing operation of the element identification module 306 of FIG. 3 in greater detail as identifying layout elements 202 from the bar chart 210 of FIG. 10.

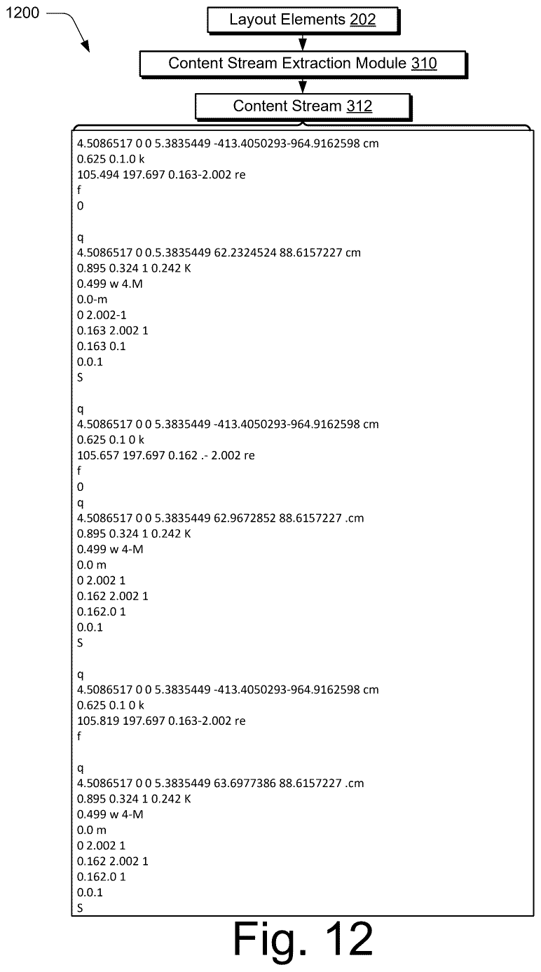

FIG. 12 depicts a system 1200 in an example implementation showing operation of the content stream extraction module 310 as extracting a content stream 312 from the digital content 122 based on the layout elements associated with the bar chart 210 of FIG. 10.

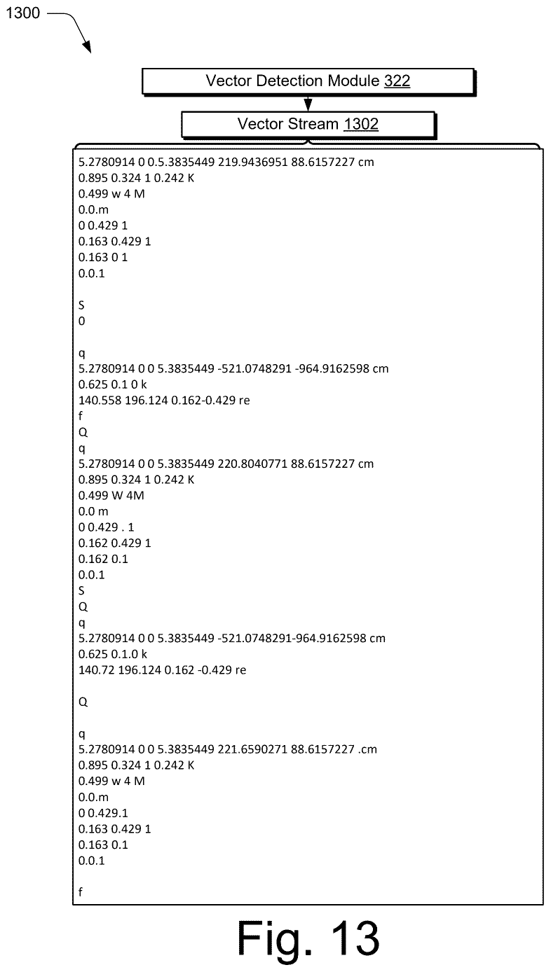

FIG. 13 depicts a system 1300 in an example implementation showing operation of a vector detection module 322 to detect a vector stream 1302 of vector operations usable to render a vector corresponding to a bar of the bar chart 210 of FIG. 10. As before, color similarity matching is performed and shows that the color operator is “0.895,” “0.324,” “1,” “0.242,” “K” which represents green in the CMYK color space. Also, an “m” operator is followed by “l” operators (e.g., four l operators) to draw a rectangle of each bar of the bar chart 210.

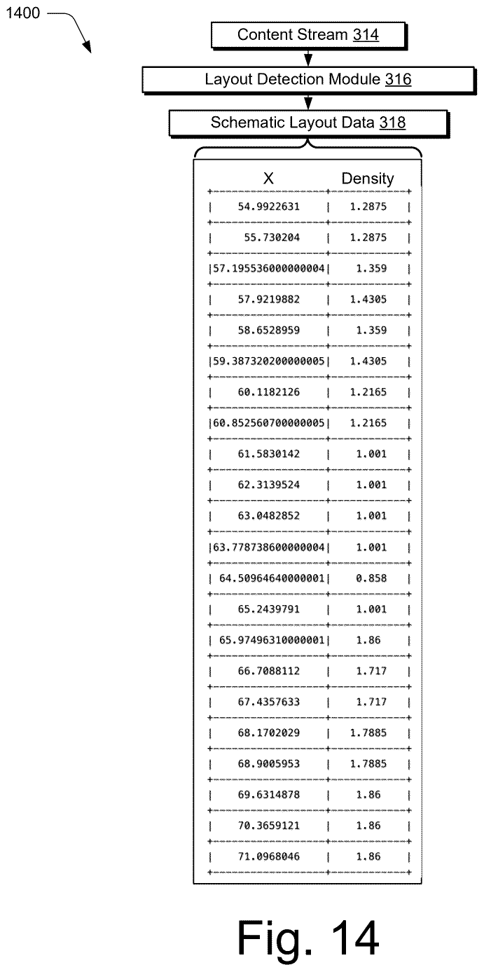

FIG. 14 depicts a system 1400 in an example implementation showing output of schematic layout data 316 by the layout detection module 314 as tabular data 318 for a green bar of the bar chart of FIG. 10.

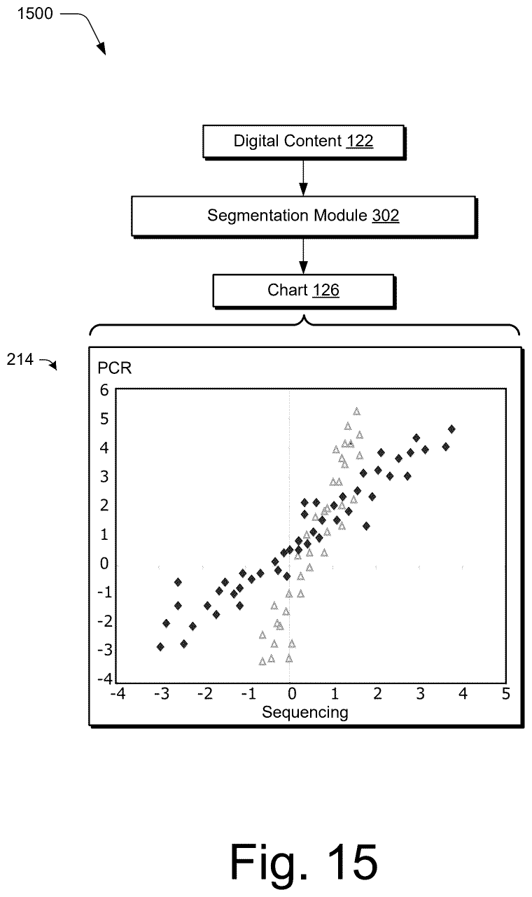

FIG. 15 depicts a system 1500 in an example implementation showing operation of the segmentation module 302 as extracting the schematic representation 120 as a chart 126 configured as a scatter plot 214.

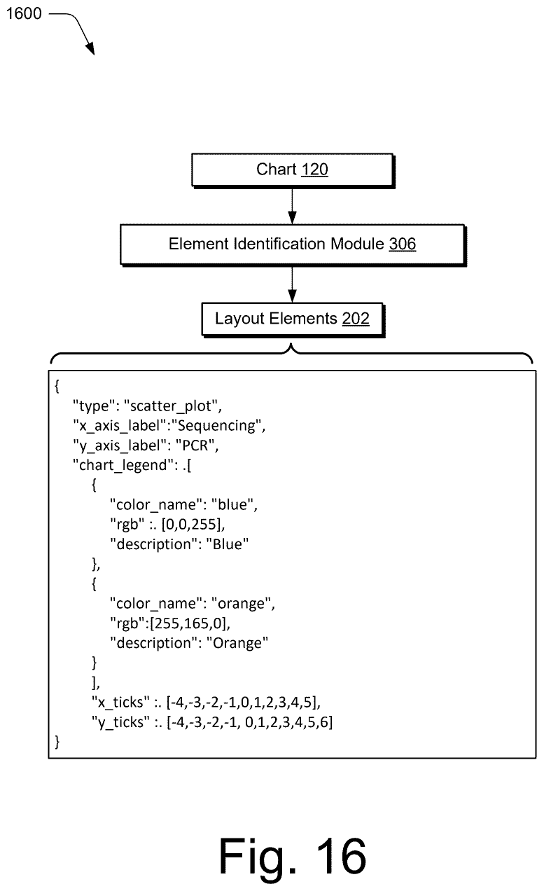

FIG. 16 depicts a system 1600 in an example implementation showing operation of the element identification module 306 of FIG. 3 in greater detail as identifying layout elements 202 from the scatter plot 214 of FIG. 15.

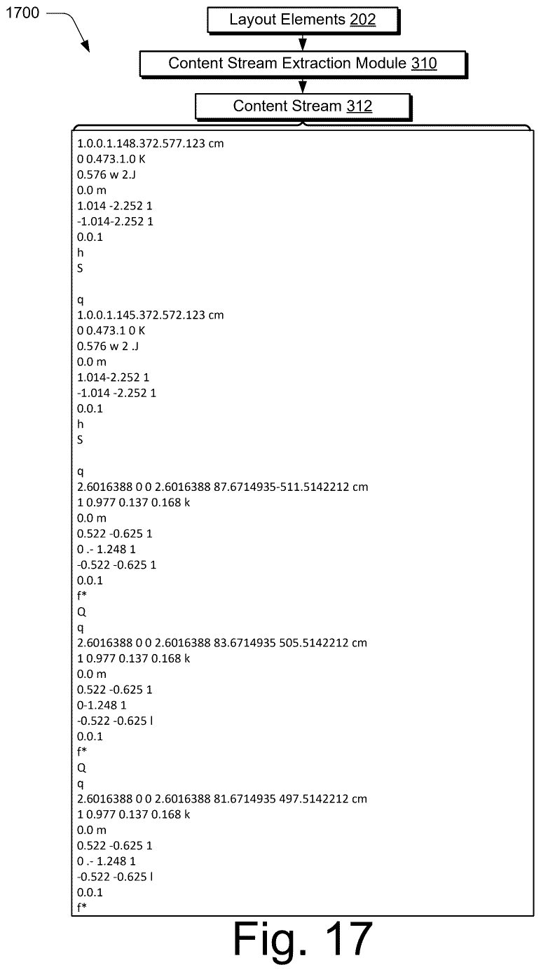

FIG. 17 depicts a system 1700 in an example implementation showing operation of the content stream extraction module 310 as extracting a content stream 312 from the digital content 122 based on the layout elements associated with the scatter plot 214 of FIG. 15.

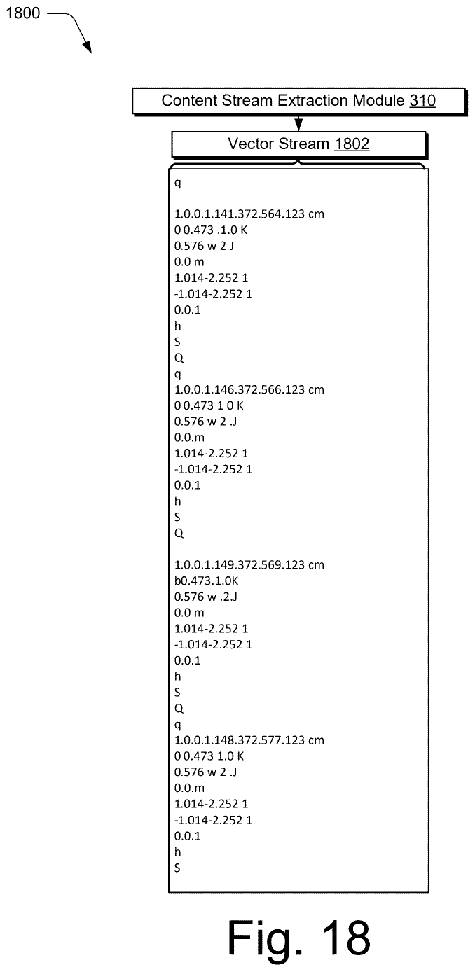

FIG. 18 depicts a system 1800 in an example implementation showing operation of a vector detection module 322 to detect a vector stream 1802 of vector operations usable to render a vector corresponding to orange triangles of the scatter plot 214 of FIG. 15. As before, color similarity matching is performed and shows that the color operator is “0,” “0.473,” “1,” “0,” “K” which represents orange in the CMYK color space. Also, an “m” operator is followed by “l” operators (e.g., three l operators) to draw three sides of the triangle for each data point.

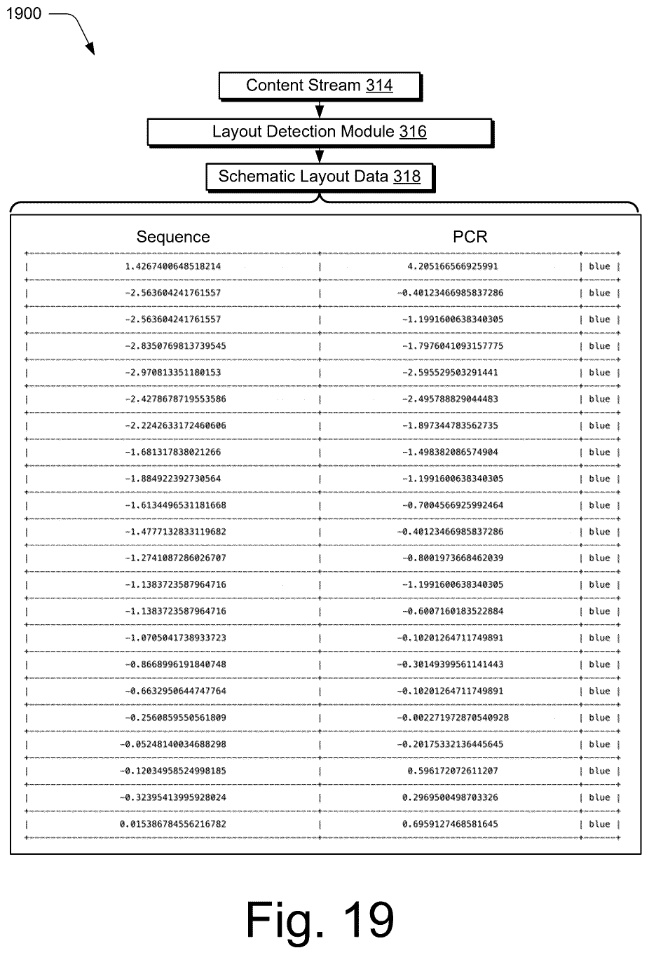

FIG. 19 depicts a system 1900 in an example implementation showing output of schematic layout data 316 by the layout detection module 314 as tabular data 318 for orange triangles of the scatter plot 214 of FIG. 15.

In this way, the schematic understanding system 116 is configurable to detect datapoints based on vectors in the schematic representation to then form a table which is consumable by a machine-learning model (e.g., an LLM) to produce a schematic understanding result. These techniques improve accuracy and computational resource efficiency when compared with conventional techniques.

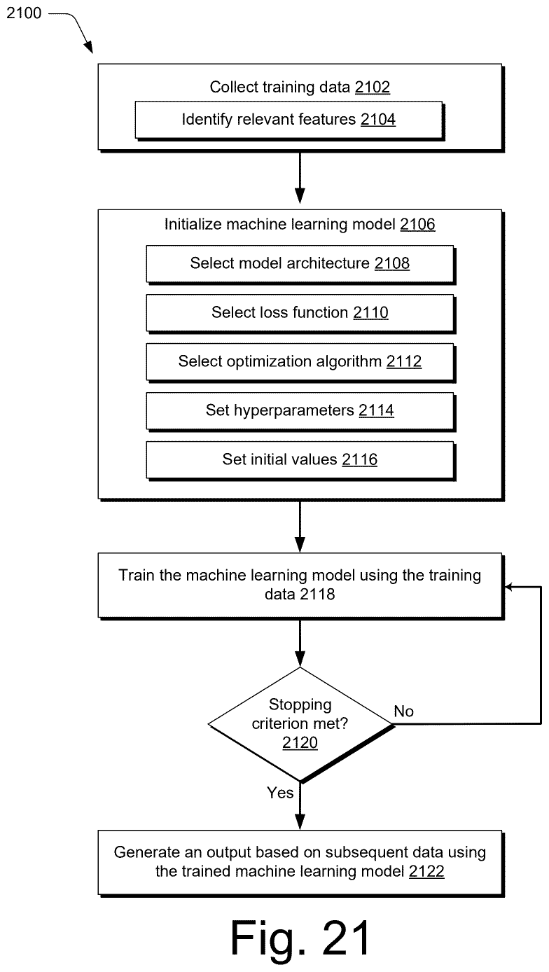

FIG. 21 is a flow diagram depicting an algorithm as a step-by-step procedure 2100 in an example implementation of operations performable for training a machine-learning model. In some embodiments, the procedure 2100 describes an operation of the training component 8221 described for configuring the machine-learning model as described with reference to FIG. 1. The procedure 2100 provides one or more examples of generating training data, use of the training data to train a machine-learning model, and use of the trained machine-learning model to perform a task.

To begin in this example, a machine-learning system collects training data (block 2102) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 2104) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 2106). Initialization of the machine-learning model includes selecting a model architecture (block 2108) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 2110). The loss function is utilized to measure a difference between an output of the machine-learning model (i.e., predictions) and target values (e.g., as expressed by the training data) to be used to train the machine-learning model. Additionally, an optimization algorithm is selected (2112) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 2114) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 2118) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 2120), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 2120), the procedure 2100 continues training of the machine-learning model using the training data (block 2118) in this example.

If the stopping criterion is met (“yes” from decision block 2120), the trained machine-learning model is then utilized to generate an output based on subsequent data (block 2122). The trained machine-learning model, for instance, is trained to perform a task as described above and therefore once trained is configured to perform that task based on subsequent data received as an input and processed by the machine-learning model.

### Example System and Device

FIG. 22 illustrates an example system generally at 2200 that includes an example computing device 2202 that is representative of one or more computing systems and/or devices that implement the various techniques described herein. This is illustrated through inclusion of the schematic understating system 116. The computing device 2202 is configurable, for example, as a server of a service provider, a device associated with a client (e.g., a client device), an on-chip system, and/or any other suitable computing device or computing system.

The example computing device 2202 as illustrated includes a processing device 2204, one or more computer-readable media 2206, and one or more I/O interface 2208 that are communicatively coupled, one to another. Although not shown, the computing device 2202 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 2204 is representative of functionality to perform one or more operations using hardware. Accordingly, the processing device 2204 is illustrated as including hardware element 2210 that is configurable as processors, functional blocks, and so forth. This includes implementation in hardware as an application specific integrated circuit or other logic device formed using one or more semiconductors. The hardware elements 2210 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 2206 is illustrated as including memory/storage 2212 that stores instructions that are executable to cause the processing device 2204 to perform operations. The computer-readable storage medium is configured for storing instructions that, responsive to execution by the processing device, causes the processing device to perform operations. The memory/storage 2212 represents memory/storage capacity associated with one or more computer-readable media. The memory/storage 2212 includes volatile media (such as random access memory (RAM)) and/or nonvolatile media (such as read only memory (ROM), Flash memory, optical disks, magnetic disks, and so forth). The memory/storage 2212 includes fixed media (e.g., RAM, ROM, a fixed hard drive, and so on) as well as removable media (e.g., Flash memory, a removable hard drive, an optical disc, and so forth). The computer-readable media 2206 is configurable in a variety of other ways as further described below.

Input/output interface(s) 2208 are representative of functionality to allow a user to enter commands and information to computing device 2202, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 2202 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 2202. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 2202, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 2210 and computer-readable media 2206 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 2210. The computing device 2202 is configured to implement particular instructions and/or functions corresponding to the software and/or hardware modules. Accordingly, implementation of a module that is executable by the computing device 2202 as software is achieved at least partially in hardware, e.g., through use of computer-readable storage media and/or hardware elements 2210 of the processing device 2204. The instructions and/or functions are executable/operable by one or more articles of manufacture (for example, one or more computing devices 2202 and/or processing devices 2204) to implement techniques, modules, and examples described herein.

The techniques described herein are supported by various configurations of the computing device 2202 and are not limited to the specific examples of the techniques described herein. This functionality is also implementable all or in part through use of a distributed system, such as over a “cloud” 2214 via a platform 2216 as described below.

The cloud 2214 includes and/or is representative of a platform 2216 for resources 2218. The platform 2216 abstracts underlying functionality of hardware (e.g., servers) and software resources of the cloud 2214. The resources 2218 include applications and/or data that can be utilized while computer processing is executed on servers that are remote from the computing device 2202. Resources 2218 can also include services provided over the Internet and/or through a subscriber network, such as a cellular or Wi-Fi network.

The platform 2216 abstracts resources and functions to connect the computing device 2202 with other computing devices. The platform 2216 also serves to abstract scaling of resources to provide a corresponding level of scale to encountered demand for the resources 2218 that are implemented via the platform 2216. Accordingly, in an interconnected device embodiment, implementation of functionality described herein is distributable throughout the system 2200. For example, the functionality is implementable in part on the computing device 2202 as well as via the platform 2216 that abstracts the functionality of the cloud 2214.

In implementations, the platform 2216 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
identifying, by a processing device, one or more layout elements included in a schematic representation in digital content;
extracting, by the processing device, a content stream from the digital content usable to render the schematic representation;
generating, by the processing device, schematic layout data by filtering the content stream and identifying data points associated with the schematic representation based on the filtered content stream; and
outputting, by the processing device, a schematic understanding result based on the schematic layout data.

2. The method as described in claim 1, wherein the schematic representation is configured as a chart, a circuit diagram, a flow diagram, or a translation invariant image representation.

3. The method as described in claim 1, wherein the schematic representation is a translation invariant image representation that contains abstractions and conveys relative component interactions.

4. The method as described in claim 1, wherein the one or more layout elements identify a title, an axis title, a location of respective said layout elements in relation to the digital content, one or more gridlines, a data series a legend, one or more ticks describing a unit a measure used for a respective said axis, a plot area, a chart area, one or more annotations, an error bar, a trendline, a mark, shading, highlighting, a color of the respective said layout elements, one or more axis labels, or a value of the respective said layout elements.

5. The method as described in claim 1, wherein the generating includes identifying the data points as corresponding to one or more vectors of a chart configured as the schematic representation.

6. The method as described in claim 1, wherein the filtering including filtering the content stream into a vector stream usable to render one or more vectors of the schematic representation and a text stream usable to render text associated with the schematic representation.

7. The method as described in claim 6, wherein the one or more vectors are used to plot the data points and wherein the identifying is based on the one or more vectors.

8. The method as described in claim 1, wherein the schematic layout data includes tabular data describing values of the data points from the schematic representation.

9. The method as described in claim 1, further comprising:
detecting coordinates of the schematic representation by segmenting the digital content using at least one machine-learning model; and
extracting the schematic representation from the digital content based on the coordinates.

10. The method as described in claim 1, wherein the digital content includes a plurality of layers and the generating the schematic layout data includes generating schematic layout data independently for each said layer and identifying one or connections between respective said layers.

11. A system comprising:
one or more computer-readable storage media; and
a processing device coupled to the one or more computer-readable storage media to perform operations including:
segmenting a chart from digital content;
extracting one or more vector operations from the digital content, the one or more vector operations associated with one or more vectors included in the chart;
generating schematic layout data by identifying data points associated with the one or more vectors of the chart based on the one or more vector operations; and
outputting a schematic understanding result in response to a query based at least in part on the schematic layout data using a machine-learning model.

12. The system as described in claim 11, wherein the generating the schematic layout data including forming a vector stream by filtering a content stream from the digital content and the extracting is based on the filtering.

13. The system as described in claim 12, wherein the filtering includes filtering the content stream into the vector stream usable to render the one or more vectors of the chart and a text stream usable to render text associated with the chart, and wherein the identifying of the data points is based on the vector stream.

14. The system as described in claim 11, wherein the schematic layout data is configured as tabular data.

15. One or more computer-readable storage media storing instructions that, responsive to execution by a processing device, causes the processing device to perform operations including:
identifying one or more layout elements included in a schematic representation included in digital content;
extracting a content stream from the digital content usable to render the schematic representation;
filtering the content stream into a vector stream usable to render one or more vectors of the schematic representation and a text stream usable to render text associated with the schematic representation;
generating schematic layout data based on the filtering.

16. The one or more computer-readable storage media as described in claim 15, wherein the schematic layout data includes tabular data describing values of data points of one or more vectors from the schematic representation.

17. The one or more computer-readable storage media as described in claim 15, wherein the schematic representation is a chart.

18. The one or more computer-readable storage media as described in claim 15, the operations further comprising:
detecting coordinates of the schematic representation by segmenting the digital content using at least one machine-learning model; and
extracting the schematic representation from the digital content based on the coordinates.

19. The one or more computer-readable storage media as described in claim 15, the operations further comprising receiving a query and outputting a schematic understanding result is based on the query and the schematic layout data using a machine-learning model.

20. The one or more computer-readable storage media as described in claim 19, wherein the machine-learning model is a large language model (LLM).
